(19) United States
(12) Patent Application Publication
(10) Pub. No.: US 2025/0217756 A1
(43) Pub. Date: Jul. 3, 2025

(54) REAL-TIME MULTI-ORDER BATCHING USING MULTIPLE COURIERS

(71) Applicant: Uber Technologies, Inc., San Francisco, CA (US)

(72) Inventors: Morteza Ashraphijuo, New York, NY (US); Jonathan Correia, San Francisco, CA (US); Emre Demiralp, San Francisco, CA (US); Nimay Desai, New York, NY (US); Shaishav Gandhi, San Francisco, CA (US); Cinar Kilcioglu, Brooklyn, NY (US); Stephan Liu, New York, NY (US); Noah Shaw, San Francisco, CA (US); Vishnu Sundaresan, Fremont, CA (US); Daniel Alex Volcinschi, New York, NY (US)

(21) Appl. No.: 18/940,228

(22) Filed: Nov. 7, 2024

Related U.S. Application Data
(60) Provisional application No. 63/615,980, filed on Dec. 29, 2023.

(51) Int. Cl. G06Q 10/0835; G06Q 10/0834

(52) U.S. Cl. CPC G06Q 10/08355; G06Q 10/0834

(57) ABSTRACT

Systems and methods for real-time multi-order batching using multiple couriers. The method includes determining that a walker courier can pick up a walking portion of a first order request and a second order request. The method includes determining that the walker courier can pick up the second order items based on (i) a current location of a computing device associated with the first walker courier, (ii) estimated time of preparation for the second item associated with the second order request, and (iii) an estimated item of arrival for the vehicle courier to a merchant area associated with the first order request and the second order request. Based on progress of assigned vehicle couriers, the transition point for the walker courier to met the vehicle courier can be computed and transmitted to the respective computing devices.

### FIELD

The present disclosure generally relates to multi-modal order couriers within a delivery service application. More particularly, the present disclosure is directed to features for utilizing walker couriers and vehicle couriers to perform different portions of order requests.

### BACKGROUND

Food delivery services allow a user to request a service that may be performed by a vehicle and/or courier. For instance, a user may request, through a food delivery service application, a food delivery service having a pick-up location, a drop-off location, and an item for delivery. A courier can be assigned to perform the food delivery service for the user. This can include transporting the delivery of the item to the drop-off location.

### SUMMARY

Aspects and advantages of embodiments of the present disclosure will be set forth in part in the following description, or may be learned from the description, or may be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include accessing data indicative of a first order request associated with a first merchant, wherein the first merchant is located within a merchant area including a plurality of merchants, the first order request including a first pick-up location and a first drop-off location. The operations include determining a first walker courier to perform a walking portion of the first order request, wherein the walking portion includes the first walker courier walking to the first pick-up location to retrieve a first item associated with the first order request. The operations include transmitting instructions to a computing device of the first walker courier, the instructions requesting the first walker courier to perform the walking portion of the first order request. The operations include determining a vehicle courier to perform a vehicle portion of the first order request, the vehicle portion including the vehicle courier delivering the first item to the first drop-off location. The operations include accessing data indicative of a second order request associated with a second merchant, wherein the second merchant is located within the merchant area and is associated with a second pick-up location. The operations include determining, based on the first order request and the second order request, that the vehicle courier can perform the vehicle portion of the first order request and a vehicle portion of the second order request. The operations include determining that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area. The operations include generating updated instructions for the first walker courier to travel to the second pick-up location. The operations include transmitting the updated instructions to the first walker courier to perform the walking portion of the second order request. The operations include based on a progress of the vehicle courier to the merchant area, computing a transition point for the walker courier to meet the vehicle courier with the first item and the second item. The operations include transmitting data indicative of the transition point to the computing device of the walker courier and a computing device of the vehicle courier.

Another example aspect of the present disclosure is directed to a computer-implemented method. The method includes accessing data indicative of a first order request associated with a first merchant, wherein the first merchant is located within a merchant area including a plurality of merchants, the first order request including a first pick-up location and a first drop-off location. The method includes determining a first walker courier to perform a walking portion of the first order request, wherein the walking portion includes the first walker courier walking to the first pick-up location to retrieve a first item associated with the first order request. The method includes transmitting instructions to a computing device of the first walker courier, the instructions requesting the first walker courier to perform the walking portion of the first order request. The method includes determining a vehicle courier to perform a vehicle portion of the first order request, the vehicle portion including the vehicle courier delivering the first item to the first drop-off location. The method includes accessing data indicative of a second order request associated with a second merchant, wherein the second merchant is located within the merchant area and is associated with a second pick-up location. The method includes determining, based on the first order request and the second order request, that the vehicle courier can perform the vehicle portion of the first order request and a vehicle portion of the second order request. The method includes determining that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area. The method includes generating updated instructions for the first walker courier to travel to the second pick-up location. The method includes transmitting the updated instructions to the first walker courier to perform the walking portion of the second order request. The method includes based on a progress of the vehicle courier to the merchant area, computing a transition point for the walker courier to meet the vehicle courier with the first item and the second item. The method includes transmitting data indicative of the transition point to the computing device of the walker courier and a computing device of the vehicle courier.

Yet another example aspect of the present disclosure is directed to one or more non-transitory computer readable media storing instructions that are executable by one or more processors to perform operations. The operations include accessing data indicative of a first order request associated with a first merchant, wherein the first merchant is located within a merchant area including a plurality of merchants, the first order request including a first pick-up location and a first drop-off location. The operations include determining a first walker courier to perform a walking portion of the first order request, wherein the walking portion includes the first walker courier walking to the first pick-up location to retrieve a first item associated with the first order request. The operations include transmitting instructions to a computing device of the first walker courier, the instructions requesting the first walker courier to perform the walking portion of the first order request. The operations include determining a vehicle courier to perform a vehicle portion of the first order request, the vehicle portion including the vehicle courier delivering the first item to the first drop-off location. The operations include accessing data indicative of a second order request associated with a second merchant, wherein the second merchant is located within the merchant area and is associated with a second pick-up location. The operations include determining, based on the first order request and the second order request, that the vehicle courier can perform the vehicle portion of the first order request and a vehicle portion of the second order request. The operations include determining that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area. The operations include generating updated instructions for the first walker courier to travel to the second pick-up location. The operations include transmitting the updated instructions to the first walker courier to perform the walking portion of the second order request. The operations include based on a progress of the vehicle courier to the merchant area, computing a transition point for the walker courier to meet the vehicle courier with the first item and the second item. The operations include transmitting data indicative of the transition point to the computing device of the walker courier and a computing device of the vehicle courier.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system for coordinating services within a merchant area using real-time multi-order batching according to aspects of the present disclosure.

FIGS. 2A-2B depict a flow diagram through various user interfaces according to example embodiments of the present disclosure.

FIG. 3 depicts a flow diagram through various user interfaces according to example embodiments of the present disclosure.

FIGS. 4-8 depict an example merchant area according to example embodiments of the present disclosure.

FIG. 9 depicts an example geographical area according to example embodiments of the present disclosure.

FIGS. 10-13 depict example user interfaces according to example embodiments of the present disclosure.

FIGS. 14 and 15 depict block diagrams of example computing systems according to example embodiments of the present disclosure.

### DETAILED DESCRIPTION

Generally, the present disclosure is directed to improved computing systems and methods for coordinating services within a merchant area using real-time multi-order batching, with walker couriers and vehicle couriers to perform different portions of the order requests. Generally, this can be implemented in areas where there is a higher density of merchants and difficulties relating to vehicle couriers getting to merchant pick-up locations (e.g., malls, food halls, city blocks). More particularly, aspects of the present disclosure relate to determining that a walker courier can perform a second service while performing a first service based on the pick-up location associated with the services, the current location of the service provider, and the drop of location of the respective services. In some instances, the computing system and method can generate a courier plan for each pending service order. The computing system can select courier plans for the pending service orders based on optimizing the overall on-trip time for the computing system as a whole.

The computing systems and methods described herein can be used in several use cases. This can include scenarios that involve walker transfers or grocery order fulfillment. For instance, the computing system can determine that an area qualifies as a restaurant hotspot. The determination can be based on the density of restaurants, a measure of the number of orders over a time period, and the physical proximity of the restaurants. Based on a determination that the area qualifies as a restaurant hotspot, the computing system can determine that walker transfer orders can be activated as a candidate courier fulfillment method.

The computing systems and methods can include accessing data indicative of a first order request which can include a pick-up location and drop-off location. The computing system can select a walker courier to perform a walking portion of the order request which can include picking up the items associated with the order and transporting them to a transition location to be picked up by the vehicle courier.

In some instances, the computing system can access data associated with a second order request (e.g., during the performance of the walking portion of the first order request). Based on the current location of the computing device associated with the first walker courier, an estimated time of preparation for one or more items associated with the second order request, and an estimated time of arrival for the vehicle courier to the merchant area, the computing system can determine that the first walker courier can pick up a second item associated with the second order request from the second merchant. Based on a progress of the vehicle courier to the merchant location, the computing system can compute a transition point for the walker courier to meet the vehicle courier with the first item and the second item. Instructions relating to the transition point can be transmitted to devices associated with the walker courier and vehicle courier.

The technology of the present disclosure can provide a number of technical effects and benefits. For instance, existing delivery computing systems perform matching based on end-to-end travel times associated with order request fulfillment. The present disclosure allows for breaking orders into a walking portion and vehicle portion and determining multiple candidate matches and batches to appropriately utilize overall computing system resources. For instance, having designated walker couriers can allow for decrease in bandwidth utilization and processing resource utilization by reducing the number of communications transmitted between the service entity and respective courier computing devices. For instance, the service entity computing system can match walker couriers to multiple walking portions of multiple order requests and send the instructions in a batch communication. Additionally, due to walker couriers' potential to sign up for availability time, less order requests will be denied thus reducing the number of transmissions between the service entity computing system and respective courier devices due to making requests to multiple couriers before being accepted.

Additionally, by performing matching and batching with a machine-learned model, the model can be continually trained and updated to make better predictions and matches moving forward. For instance, a feedback loop can be created that corrects the models to better predicted estimated preparation times, estimated time of arrivals, or other predictions used to match or batch couriers to walking portions or vehicle portions of respective order requests. Thus, the present disclosure provides for numerous technical effects and benefits that improve the functionality of a computing system (and its associated hardware) to deliver the operations and techniques described herein.

Further advantages include updating graphical user interfaces to display messages based on data obtained from multiple devices in a distributed system. For instance, the alteration of a current location of a first courier device can result in an update for a walker courier device's graphical user interface. This can allow for better utilization of the available display area by providing emphasis on important features of the display (e.g., notifications, updates to instructions) and continual updating based on real-time data that is obtained.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. With reference to the figures, example embodiments of the present disclosure will be discussed in further detail.

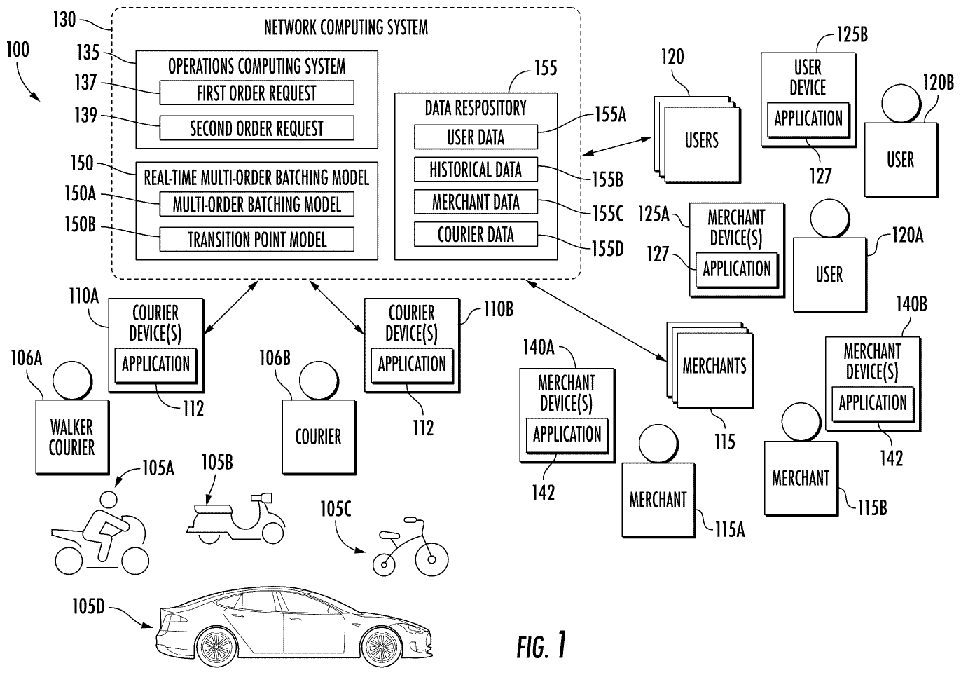

FIG. 1 depicts a block diagram of an example computing system 100 for real-time multi-order batching using multiple couriers. As illustrated, FIG. 1 shows a computing system 100 that can include a one or more vehicles 105A-D (e.g., a car, scooter, motorcycle, bicycle) and one or more courier devices 110A and 110B that can be associated with one or more couriers 106A and 106B. In some examples, the one or more couriers are humans. In some instances, the courier can be a walker courier 106A. A walker courier can be an individual that transports an item by foot. The walker courier 106A can be associated with a walking “vehicle” or pedestrian designation. Courier 106B can be a walker courier, vehicle courier, or any other courier.

In some examples, the courier can be non-human (e.g., vehicle, autonomous vehicle, autonomous robot).

The one or more couriers and the one or more courier devices 110A and 110B (e.g., an onboard tablet, a mobile device of a courier) can be associated with the one or more vehicles 105A-D. The courier device(s) 110A and 110B can include a software application 112 associated with the food delivery service entity, which can run on the courier device(s) 110A and 110B.

The computing system 100 can include one or more merchants 115. The merchants 115 can receive data indicative of a food delivery order request from a user 120A or 120B of users 120. For example, the user 120 can submit a request through a user device 125A or 125B associated with the user (e.g., via a software application 127). A network computing system 130 can include a computing system associated with a service entity that can facilitate a request for services from one or more users 120, such as user 120A and user 120B. An operations computing system 135 associated with the food delivery service entity can facilitate a one or more request for services from users 120. For example, the user 120A can submit a food delivery request through a user device 125A associated with the user 120A (e.g., via a software application 127). Operations computing system 135 can receive a food delivery order request for a first order request 137 from a user device 125A. The operations computing system 135 can send data indicative of the first order request 137 to a merchant device 140A associated with a merchant 115A (e.g., via a software application 142).

The operations computing system 135 can determine that the first order request 137 is a candidate order request for being divided into a walker courier portion and a vehicle courier portion. For instance, the merchant 115A associated with the order request can be located at a merchant area. The merchant area can include a number of merchants that can be traveled to more easily by foot (e.g., via a walker courier) than by an end-to-end courier that must find parking, travel to the merchant, travel back to the vehicle, and then deliver the item to the user that placed the order request. A merchant area can include a mall, food court, shopping center, densely populated area, or any other similar area. As such, the real-time multi-order batching can be performed.

The operations computing system 135 can receive data indicative of a merchant 115A accepting a food preparation request (e.g., food being prepared, estimated preparation time). The operations computing system 135 can send a request to a courier device 110A associated with the walker courier 106A to complete the walking portion of the first order request 137 (e.g., via application 112). The operations computing system 135 can send a request to a courier device 110B associated with a courier 106B to complete a vehicle portion of the first order request.

The operations computing system 135 can receive data indicative of a number of order requests, including second order request 139. The operations computing system 135 can send data indicative of the second order request 139 to a merchant device 140B associated with a merchant 115B (e.g., via a software application 142).

The operations computing system 135 can determine that the second order request 139 is a candidate order request for being divided into a walker courier portion and a vehicle courier portion. For instance, the merchant 115B associated with the order request can be located at a merchant area. The merchant area can include a number of merchants that can be traveled to more easily by foot (e.g., via a walker courier) than by an end-to-end courier that must find parking, travel to the merchant, travel back to the vehicle, and then deliver the item to the user that placed the order request. As such, the real-time multi-order batching can be performed. For instance, the operations computing system 135 can determine whether to use the first walker courier 106A to perform the walker portion of the second order request or determine a second walker courier to perform the walker portion of the second order request.

The operations computing system 135 can receive data indicative of a merchant 115B accepting a food preparation request (e.g., food being prepared, estimated preparation time). The operations computing system 135 can send a request to a courier device (e.g., courier device 110A) associated with the walker courier (e.g., walker courier 106A or another courier) to complete the walking portion of the second order request 139 (e.g., via application 112). The operations computing system 135 can send a request to a courier device (e.g., courier device 110B) associated with a courier (e.g., courier 106B or another courier) to complete a vehicle portion of the second order request.

The network computing system 130 can include a real-time multi-order batching model 150. In some instances, the real-time multi-order batching model 150 can include a multi-order batching model 150A or a transition point model 150B. In some instances, the multi-order batching model 150A and transition point model 150B can be the same model. The multi-order batching model 150A can obtain input including currently active order requests, availability of couriers, courier device locations, merchant data, and other relevant data to determine pairings of walker couriers, vehicle couriers, merchants, and orders. The pairings can include determining pairings of walker couriers and vehicle couriers for order requests including determining whether a walker courier or vehicle courier can perform multiple orders at the same time (e.g., batch the orders).

The network computing system 130 can include a data repository 155. The data repository 155 can include user data 155A (e.g., data associated with user 120), historical data 155B (e.g., data associated with user(s) 120, data associated with merchant(s) 115, data associated with couriers), merchant-specific data 155C (e.g., real-time data associated with merchants 115), and/or any other relevant data (e.g., computing system-level data associated with a plurality of users, expected demand). The real-time multi-order batching model 150 can use data from the data repository 155 to determine when or how to batch orders.

The operations computing system 135 can generate data indicative of the first order request 137 and/or second order request 139 (e.g., estimated time of departure, estimated time of arrival, estimated preparation time, real-time updates on order preparation, real-time updates on order location). The operations computing system 135 can provide data for display on a user device 125A (e.g., via application 127) indicative of updates on the first order request 137 and/or provide updates for display on a user device 125B (e.g., via application 127) indicative of updates on the second order request 139. For example, an update can include an update about what stage of delivery the primary order is in (e.g., preparation, pick-up by courier, courier in route, approaching delivery, delivered). In addition, or alternatively, the update can include an update about what stage of delivery the second order is in (e.g., preparation, pick-up by courier, courier in route, approaching delivery, delivered).

An operations computing system 135 associated with the service entity can receive a first order request 137 from the user device 125A. The operations computing system 135 can send a request to a courier device 110A associated with a walker courier 106A (e.g., via a software application 112) for the courier to perform a walking portion of the first order request service. The courier can be associated with a walking vehicle. Additionally, the operations computing system 135 can send a request to a courier device 110B associated with a vehicle courier 106B (e.g., via application 112) for the courier to perform a vehicle portion of the first order request. The courier 106B can be associated with a vehicle (e.g., vehicle 105A-D).

The operations computing system can communicate data indicative of the order requests assignment to a courier (e.g., a walker courier, a human courier, an autonomous vehicle courier, an autonomous robot courier). For instance, the operations computing system 135 can send a request to the courier device 110A or 110B of the courier 106A and 106B. The request (e.g., for the courier to accept the food delivery service assignment) can be communicated to the courier via the software application 112 running on the courier device 110B associated with the courier. Additionally, or alternatively, the operations computing system 135 can send a request to a courier device(s) 110B (e.g., a tablet stored onboard the vehicle) of at least one of vehicles 105A-D. The request (for the courier to accept the food delivery service assignment) can be communicated to the courier via the software application 112 running on a courier device 110A or 110B. The courier can provide user input to the courier device 110A or 110B (e.g., via the software application 112) to accept or decline the vehicle service assignment. In some examples, user input can be provided directly into a service application. Additionally, or alternatively, user input can be provided via an application programing interface (API) and/or a third-party application. Data indicative of the acceptance or rejection of the request can be provided to the operations computing system 135.

As the one or more service requests are being fulfilled, the graphical user interfaces of the respective courier devices 110A or 110B of the courier 106A or 106B can be automatically updated to provide instructions relating to a location to meet for the transition point (e.g., handoff) and automatically updated based on performance of prerequisite actions (e.g., automatically marking the trip as completed for the walker courier when the vehicle courier has marked the handoff as completed).

The computing systems of FIG. 1 can batch one or more order requests using a real-time multi-order batching model. For example, the real-time multi-order batching model 150 can be used to coordinate services within a merchant area using real-time multi-order batching to batch orders or determine transition point for the order to be transferred from a walker courier to a vehicle courier.

In some implementations, the machine-learned models described herein can be trained at a training computing system and then provided for storage and/or implementation at one or more computing devices, as described above. For example, a model trainer can be located in the training computing system. The training computing system can be included in or separate from the one or more computing devices that implement the machine-learned model. In some implementations, the model can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

In some implementations, the model trainer can perform centralized training of the machine-learned models (e.g., based on a centrally stored dataset). In other implementations, decentralized training techniques such as distributed training, federated learning, or the like can be used to train, update, or personalize the machine-learned models.

The machine-learned models described herein can be trained according to one or more of various different training types or techniques. For example, in some implementations, the machine-learned models can be trained using supervised learning, in which the machine-learned model is trained on a training dataset that includes instances or examples that have labels. The labels can be manually applied by experts, generated through crowdsourcing, or provided by other techniques (e.g., by physics-based or complex mathematical models). In some implementations, if the user has provided consent, the training examples can be provided by the user computing device. In some implementations, this process can be referred to as personalizing the model.

As one example, a machine-learned model is trained on training data that includes example input data that has labels. Training processes other than the example process described can be used as well.

In some implementations, training data can include examples of the input data that have been assigned labels that correspond to the output data. For example, determining whether an order qualifies for a walker courier to perform a portion of the order, transition point determination, or batching orders can be performed using a machine-learned model such as the real-time multi-order batching model that is trained using training data gathered by the computing system. This training data can include data associated with the couriers, features associated with types of order requests, fulfillment time, unexpected changes in demand, or other data. The data associated with couriers can include courier type (e.g., walker or motorized vehicle), courier wait time, courier travel time, number of order requests completed, and/or other related data. The data associated with the merchants can include category labels (e.g., machine learning based prediction of cuisine type), incremental distance (e.g., incremental haversine distance, incremental ETA), merchant status (e.g., accepting orders or not accepting orders), food preparation time (e.g., for each individual item), rating, and/or delivery-related features.

In some implementations, during training, the input training data can be intentionally deformed in any number of ways to increase model robustness, generalization, or other qualities. Example techniques to deform the training data include adding noise; changing color, shade, or hue; magnification; segmentation; amplification; etc.

In some implementations, the machine-learned model can be trained by optimizing an objective function. For example, in some implementations, the objective function can be or include a loss function that compares (e.g., determines a difference between) output data generated by the model from the training data and labels (e.g., ground-truth labels) associated with the training data. For example, the loss function can evaluate a sum or mean of squared differences between the output data and the labels. As another example, the objective function can be or include a cost function that describes a cost of a certain outcome or output data. Other objective functions can include margin-based techniques such as, for example, triplet loss or maximum-margin training.

One or more of various optimization techniques can be performed to optimize the objective function. For example, the optimization technique(s) can minimize or maximize the objective function. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some implementations, backward propagation of errors can be used in conjunction with an optimization technique (e.g., gradient based techniques) to train a model (e.g., a multi-layer model such as an artificial neural network). For example, an iterative cycle of propagation and model parameter (e.g., weights) update can be performed to train the model. Example backpropagation techniques include truncated backpropagation through time, Levenberg-Marquardt backpropagation, etc.

In some implementations, the machine-learned models described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

In some implementations, the machine-learned models described herein can be trained using semi-supervised techniques which combine aspects of supervised learning and unsupervised learning.

In some implementations, the machine-learned models described herein can be trained or otherwise generated through evolutionary techniques or genetic algorithms.

In some implementations, the machine-learned models described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some implementations, one or more generalization techniques can be performed during training to improve the generalization of the machine-learned model. Generalization techniques can help reduce overfitting of the machine-learned model to the training data. Example generalization techniques include dropout techniques; weight decay techniques; batch normalization; early stopping; subset selection; stepwise selection; etc.

In some implementations, the machine-learned models described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques can be used to provide an initial model from which to begin training of the machine-learned models described herein.

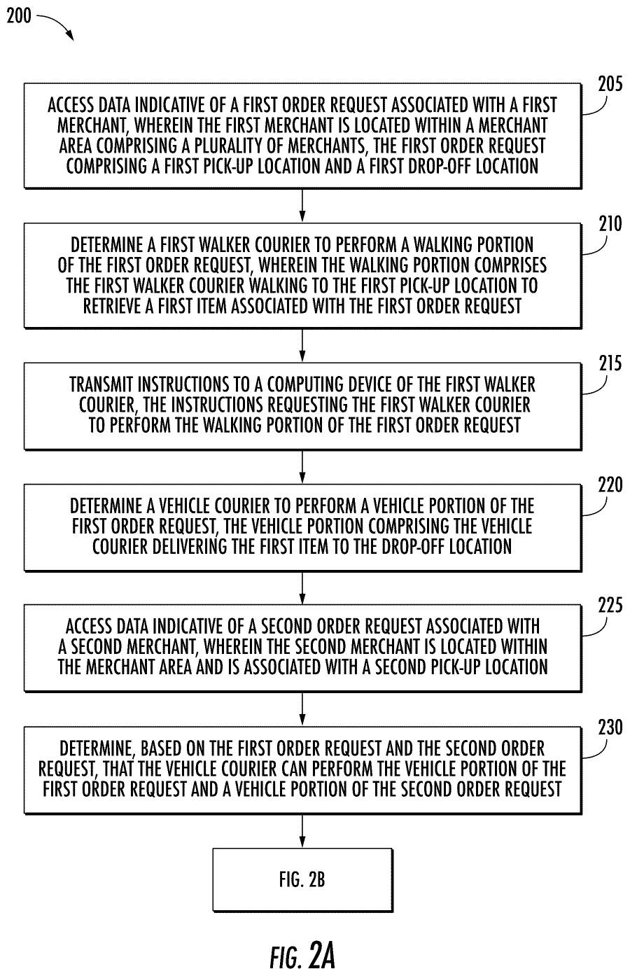

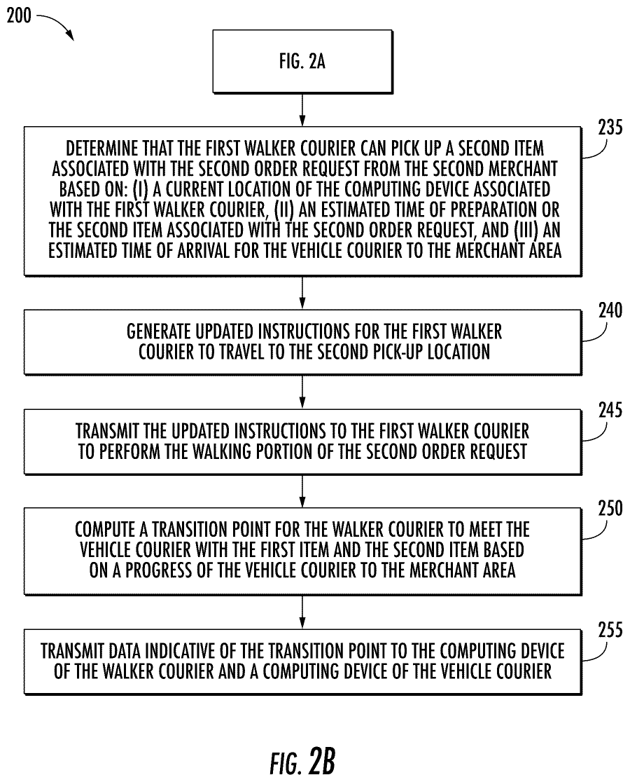

FIG. 2A and FIG. 2B depict a flowchart diagram of an example method for a coordinating services within a merchant area using real-time multi-order batching according to example embodiments of the present disclosure. One or more portion(s) of method 200 can be implemented by processing logic on one or more computing devices such as, for example, the computing devices/computing systems described in FIGS. 1, 14 and 15. Moreover, one or more portion(s) of the method 200 can be implemented as an algorithm on the hardware components of the device(s) described herein (e.g., as in FIGS. 1, 14, and 15). For example, a computing system can include one or more processors and one or more non-transitory, computer-readable media storing instructions that are executable by the one or more processors to cause the computing system to perform operations, the operations including one or more of the operations/portions of method 200. FIG. 2A and FIG. 2B depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At operation 205, processing logic can access data indicative of a first order request associated with a first merchant, wherein the first merchant is located within a merchant area including a plurality of merchants, the first order request including a first pick-up location and a first drop-off location.

At operation 210, processing logic can determine a first walker courier to perform a walking portion of the first order request. The walking portion can include the first walker courier walking to the first pick-up location to retrieve a first item associated with the first order request. By way of example, the walker can be located at a shopping mall with a food court, a densely populated city block, a restaurant hall, or some other locale with multiple merchants.

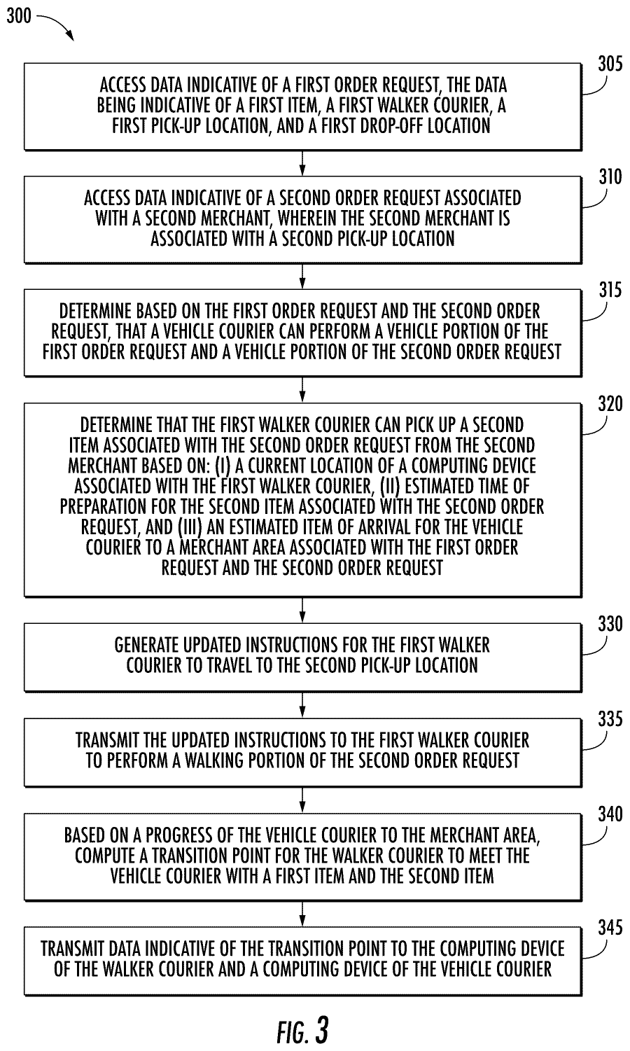

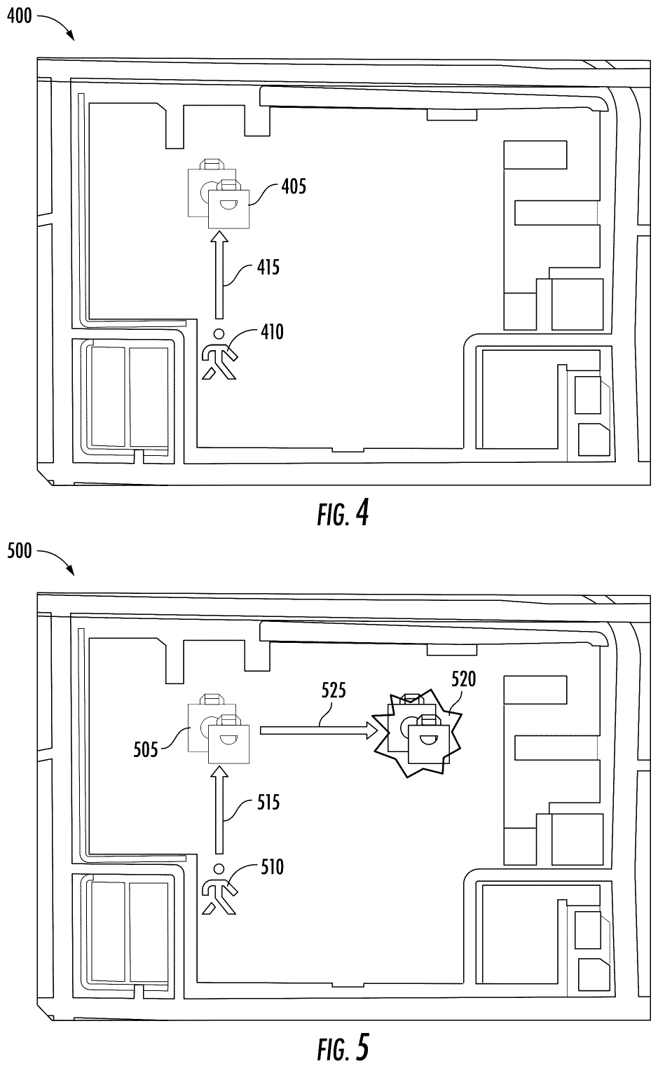

FIG. 4 to FIG. 8 depict example merchant areas that will be used in connection with FIG. 2 and FIG. 3 to illustrate an example method for coordinating services within a merchant area using real-time batching.

FIG. 4 depicts an example merchant area 400. The merchant area includes a plurality of merchants which include a first pick-up location 405 associated with a merchant associated with the first order request. The computing system can determine the first walker 410 to perform the walking portion of the first order request. The computing system can generate a suggested path 415 for the first walker 410 to travel from a current location of the first walker courier to the first pick-up location. The first walker 410 can have a computing device with location determining hardware. The computing system can utilize the location determining hardware to make real-time decisions about the current and future order requests that may be obtained.

In some implementations, determining the first walker courier to perform the walking portion of the first order request can be performed by matching the walker courier to perform the walking portion of the first order request. For instance, the method can include determining a plurality of candidate walker couriers based on data indicative of the plurality of candidate walker couriers being located at the merchant area. The method can include providing the plurality of candidate walker couriers and order request data, as input into a machine-learned model. The system can determine that the plurality of candidate walker couriers are located at the merchant area utilizing location determining hardware of the walker courier devices. Location determining hardware can include, for example, global positioning system (GPS), cellular connection data, Bluetooth data, or sensor data of the device. Additionally, or alternatively, the system can obtain data provided by the user indicative of arrival at a merchant area or selecting an online status for the device at the merchant area.

In some implementations, the method can include providing the plurality of candidate walker couriers and order requests data to a numerical solve component. For instance, a number of estimated time of arrivals, estimated time of preparation, or other relevant times can be estimated. The estimated times can be used as input into a numerical solve to determine a selected option (e.g., walker courier and vehicle courier). The method can include obtaining, as output from the machine-learned model, a plurality of matches between order requests and walker couriers. For instance, the numerical solver can score all potential pick-up plans and combinations and select a chosen pick-up plan. In some implementations a machine learned model can be used to determine an estimated pick-up waypoint time, order preparation time, or other times associated with completing pick-up or tradeoff of the order. The estimated values can be used as input into the numerical solver to select a plan with a score exceeding the other candidate plans. In some instances, the numerical solver can be performed for a number of open order requests and candidate delivery plans (e.g., combinations of walker couriers and vehicle couriers) to optimize for the overall number of orders opposed to a single order request.

In some instances, determining the inputs for the numerical solve can include determining courier availability. For instance, the system can scan or query for all couriers who satisfy candidate selection criteria. For example, courier selection criteria can include a vehicle time, a distance from pick-up location, or other rules associated with courier selection criteria.

As described herein, the method can include determining, using a machine-learned model, that the first order request is eligible for a walker courier based on (i) pick-up logistics associated with the merchant area, (ii) one or more pick-up waypoint times, (iii) order preparation time, (iv) courier availability, or (v) time of day. In some implementations, the method can include determining, using a numerical solve, that the first order request is eligible for a walker courier.

The pick-up logistics associated with the merchant area include: (i) parking availability, (ii) historical time spent at merchant area, or (iii) street geography. For instance, a location with free parking or reserved parking for delivery drivers or to-go pick-ups can be associated with being less likely to need a walker courier. Historical time spent at merchant area can include data indicative of time spent by couriers at merchant areas from the time the courier arrives to the area, picks up the order, and returns to the vehicle to perform the vehicle portion of the order request. Street geography can be associated with one-way streets or other road features that may affect a preferred transition location to be determined. For instance, if one side of a shopping center is located on a main, busy street, a calmer back side of the building can be preferred for pick-up. If a building has two one-way streets, the beginning location of the vehicle courier and the drop-off location associated with the order request can be utilized to appropriately position the transition location to reduce the travel time for the vehicle courier (e.g., by having to go around a block to turn around). Additionally, the location.

Pick-up waypoint times can be associated with the time it takes from arrival to a merchant area to the pick-up location, wait time, and time from the pick-up location to resuming the vehicle portion of the order request when a single courier is performing the request end-to-end. The order preparation time can be determined based on historical order preparation time for similar items from the same or similar merchants, other existing order requests for the same merchants, predicted increases in order demand. The courier availability can include an indication of a number of available walker couriers and driver couriers. The computing system can aim to appropriately utilize the entire population of walker couriers and driver couriers to determine matches between couriers and order requests such that overall courier time is reduced. These considerations can also be utilized for determining when to batch order requests based on comparing counterfactuals including estimated time for a walker courier plus a vehicle courier performing the order compared to a single courier performing the request, compared to alternative pairs of walkers and couriers, or any other relevant counterfactuals. Time of day can include data associated with times of day that are busier than others and can include data associated with anticipated increase or decrease in demand due to events, holidays, closings, construction, or other events that can affect courier availability.

In some instances, the machine-learned model can be trained. For instance, the method can include obtaining data associated with courier times for a plurality of order requests associated with the merchant area. A portion of the plurality of order requests can be associated with walker courier order requests and a second portion of the plurality of order requests are end-to-end courier requests. The method can include updating the machine-learned model to better predict when courier time is reduced based on the obtained data. The data associated with the first portion of the plurality of order requests associated with walker courier order requests can include a trips per hour count.

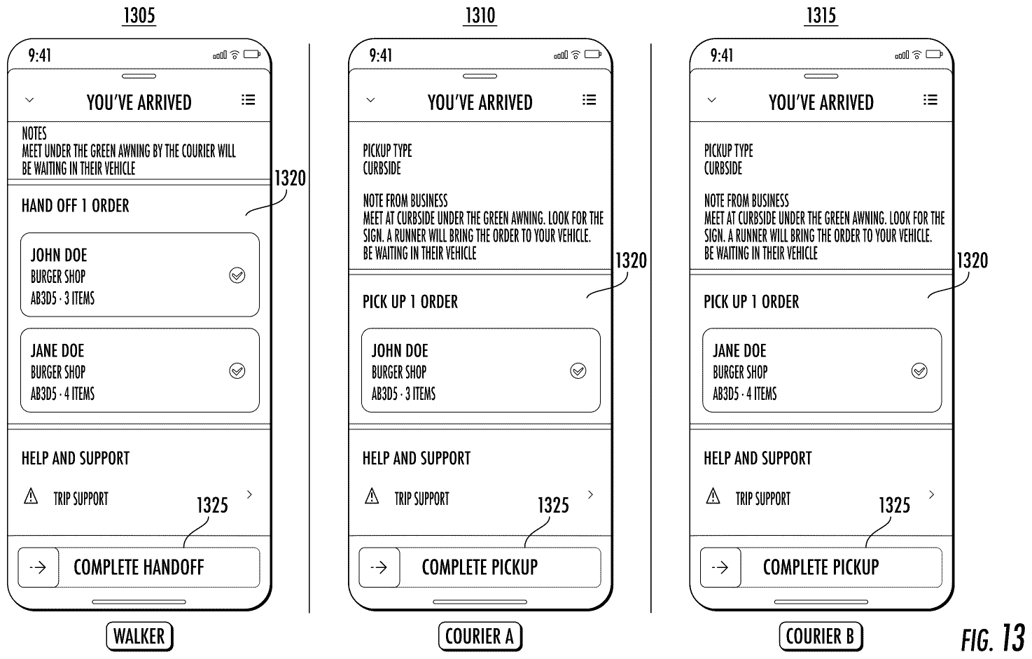

At operation 215, processing logic can transmit instructions to a computing device of the first walker courier. The instructions can include requesting the first walker courier to perform the walking portion of the first order request. As described herein, the instructions that are transmitted can cause a graphical user interface of the computing device to update. For instance, the graphical user interface can update to provide relevant information for completing the service request. Examples of graphical user interface updates for batched order requests is depicted in FIG. 12 to FIG. 15.

At operation 220, processing logic can determine a vehicle courier to perform a vehicle portion of the first order request. The vehicle portion can include the vehicle courier delivering the first item to the drop-off location. For instance, the vehicle portion can include the vehicle courier picking up the first item from a transition location and delivering the first item to the drop-off location.

At operation 225, processing logic can access data indicative of a second order request associated with a second merchant The second merchant can be located within the merchant area and can be associated with a second pick-up location.

At operation 230, processing logic can determine, based on the first order request and the second order request, that the vehicle courier can perform the vehicle portion of the first order request and a vehicle portion of the second order request. For instance, the method can include determining that the vehicle portion of the first order request and the vehicle portion of the second order request can be batched. Determining that the orders can be batched can be based on a number of factors. For instance, the factors can include the types of items in the respective order requests, the anticipated preparation time of the respective order requests, and/or the drop-off locations of the respective order requests.

As described herein, determining that the vehicle courier can perform the vehicle portion of the first order request and the vehicle portion of the second order request can be based on a spatial proximity of the first drop-off location and a second drop-off location associated with the second order request. For instance, the spatial proximity can be a proximity determined based on order type, time of day, predicted travel time, and the like. For instance, spatial proximity can be based on a haversine distance or based on expected travel time (e.g., isochrones). By way of example, if an order is for an item that can melt, the order may be less likely to be batched with another time sensitive order that would require a delivery before the item that can melt (e.g., based on a priority order status, or some other determination). In some instances, items in an order can be free of sensitive timing restraints and allow for larger range of batching locations among drop-off locations.

Continuing with method 200 and turning to FIG. 2B, at operation 235, processing logic can determine that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area.

At operation 240, processing logic can generate updated instructions for the first walker courier to travel to the second pick-up location.

As depicted in FIG. 5, the merchant area 500 can include the first pick-up location 505, the first walker courier 510, and the first suggested path 515. The second order request can be associated with the second pick-up location 520. The method can include determining a suggested path 525 for the first walker courier 510 to take from the first pick-up location to the second pick-up location. The updated instructions can be transmitted to the first walker courier as depicted in FIG. 2B.

At operation 245, processing logic can transmit the updated instructions to the first walker courier to perform the walking portion of the second order request. For instance, a graphical user interface the courier device of the first walker courier can be modified to display a message including details relating to the walking portion of the second order request including a pick-up location associated with the second order request.

At operation 250, processing logic can compute a transition point for the walker courier to meet the vehicle courier with the first item and the second item based on a progress of the vehicle courier to the merchant area. For instance, based on determining that a walker courier is closer to a secondary exit of the merchant area as the vehicle courier is expected to arrive, the transition point for the walker courier to meet the vehicle courier can be adjusted to reduce wait time. For instance, reduction in time that the walker courier is waiting on the vehicle courier to arrive at the transition point and vice versa can be accounted for in determining the transition point.

Turning to FIG. 6, merchant area 600 can include a transition point 625 and a suggested path 630 from the second pick-up location 620 to the transition point 625 for the first walker courier 605. The transition point can include a place for the first walker courier 605 to hand off the items associated with the first and second order requests to the vehicle courier. Additionally, or alternatively, the transition point can include a storage space such that the first walker courier 605 can drop-off the items at the transition point and continue with a next order request. In some instances, the method includes timing the instructions transmitted to the first walker courier and the vehicle courier such that their arrival to the transition point is nearly simultaneous (e.g., reduces the wait time of both couriers).

As described herein, there can be an initial transition point associated with the first order request. Determining the transition point can include updating the initial transition point. For example, the method can include continuously determining the location of a device associated with the first walker courier 605 and a location of a device associated with the vehicle courier and determining an estimated time of arrival of both couriers to the initial transition point. The method can include determining a difference between the two estimated times of arrivals. In some instances, a new transition point can be determined based on determining that the new transition point would result in a smaller difference between the two estimated time of arrivals as compared to the initial transition point. As such, the method can include updating the instructions based on real-time location data obtained from location determining hardware of devices associated with the couriers.

At operation 255, processing logic can transmit data indicative of the transition point to the computing device of the walker courier and a computing device of the vehicle courier. The data indicative of the transition point can include a location of the transition point, directions for a route to get to the transition point, photographs or graphical renderings of the transition point, or any other data relevant to the transition point.

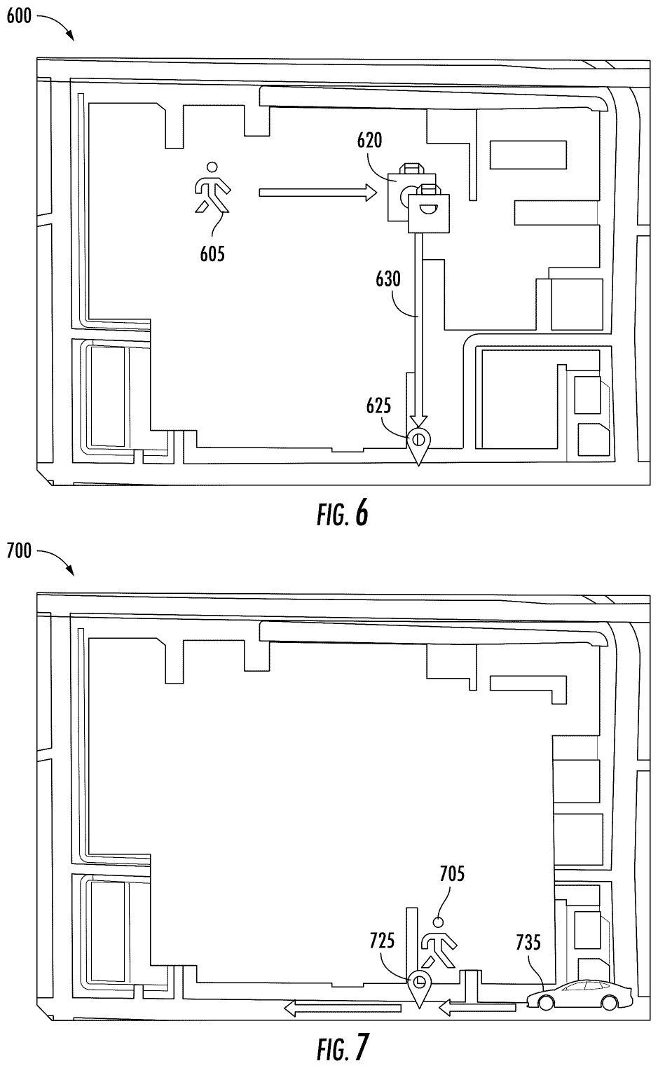

As depicted in FIG. 7, the merchant area 700 can include the first walker courier 705 meeting the vehicle courier 735 at the transition point 725 to hand off the items associated with the respective order requests to be delivered by the vehicle courier.

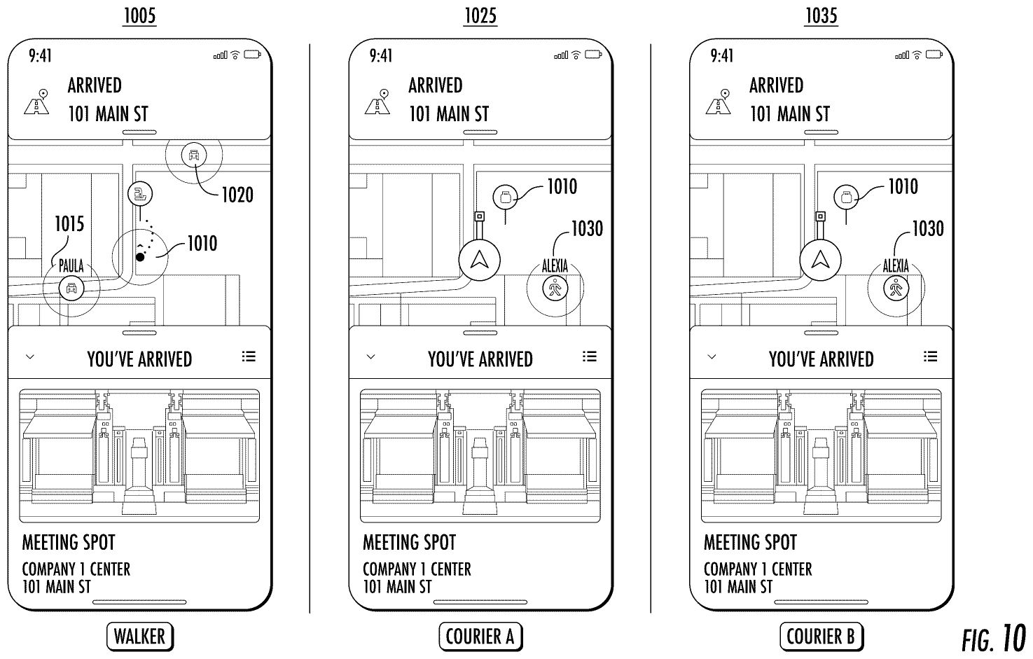

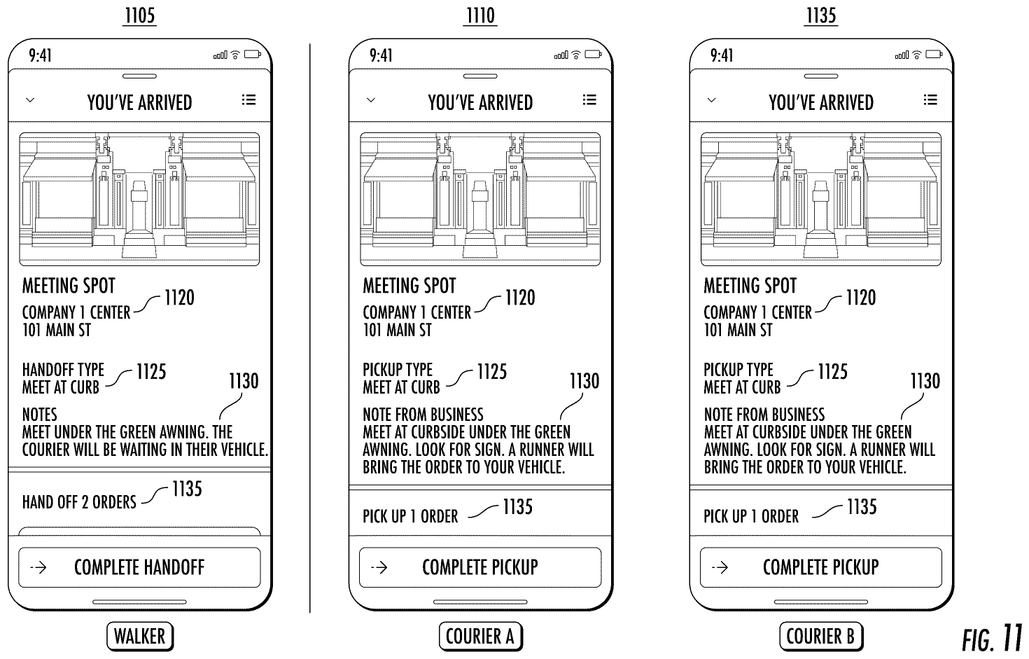

FIG. 10 to FIG. 13 depict example graphical user interfaces associated with the walker courier and vehicle couriers coordinating travel to the transition point 725. For instance, in some implementations, a first walker courier can be assigned a walking portion of multiple order requests. In some implementations, the vehicle portions of the same requests can be assigned to different vehicle couriers. As such, a challenge is ensuring that the correct orders are transferred (e.g., handed off) to the correct vehicle courier.

FIG. 10 depicts example user interfaces for the respective couriers. For instance, a walker courier user interface 1005 can include instructions relating to navigating to the transition point 1010. Additionally, walker courier user interface 1005 can include real-time information about the first courier location 1015 and second courier location 1020. The locations of the respective courier devices can be determined in real-time using location-determining hardware of the respective computing devices. A first vehicle courier user interface 1025 can include instructions relating to navigating to the transition point 1010. Additionally, first vehicle courier user interface 1025 can include real-time information about the walker courier location 1030. A second vehicle courier user interface 1035 can include instructions relating to navigating to the transition point 1010. Additionally, second vehicle courier user interface 1035 can include real-time information about the walker courier location 1030.

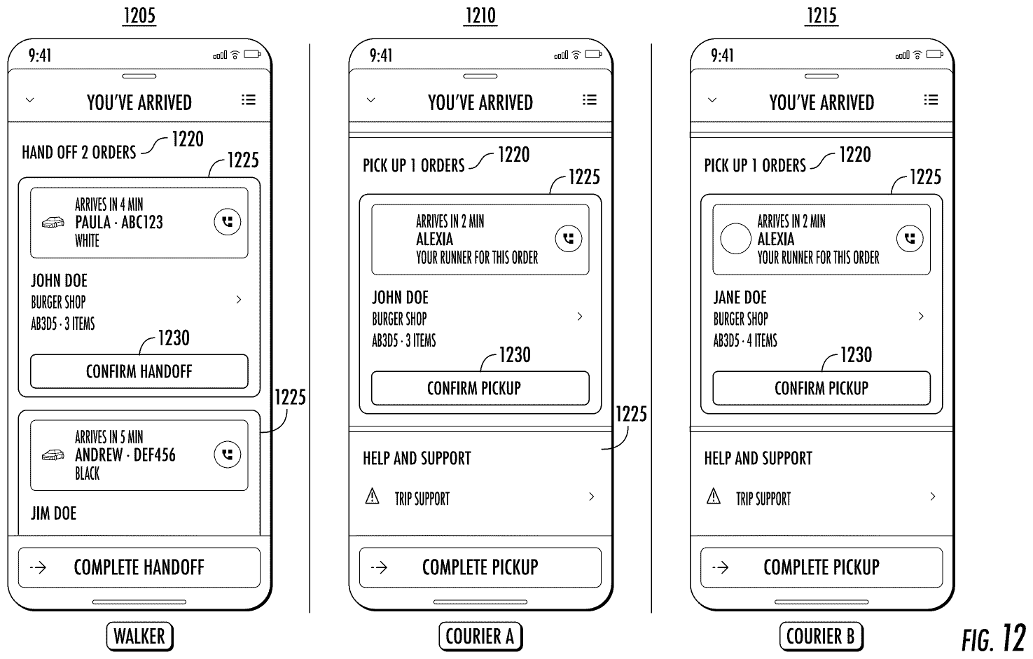

FIG. 11 depicts example user interfaces for courier devices for completing a service request where two walking portions of orders have been batched to a single walker courier and two vehicle couriers are performing the vehicle portion of the service request. More particularly, FIG. 11 depicts a walker courier user interface 1105, a first vehicle courier user interface 1110, and a second vehicle courier user interface 1115. For instance, each respective courier user interface can include a meeting spot 1120, handoff/pick-up type 1125, notes 1130, and a number of orders 1135. The meeting spot 1120 can include an address for identifying the location of the meeting spot (e.g., transition point) where the walker courier and vehicle couriers mee to transfer the items of the orders. The handoff/pick-up type 1125 can include an indication of the type of pick-up. The type of pick-up can include curbside, designated parking spots, or other pick-up types. The number of orders 1135 can provide an indication of the number of orders being handed off or picked up by the respective couriers.

As described herein, FIG. 11 depicts an example where the walker courier had two orders to handoff but is handing off to two different vehicle couriers. Thus, in walker courier user interface 1105, number of handoff orders is two and the first vehicle courier user interface 1110 and second vehicle courier user interface 1115 have a number of pick-up orders set at once. Additional or alternative implementations can include the utilization of two walker couriers and a single vehicle courier, utilization of two walker couriers and two vehicle couriers. Or any other combination of a number of orders, number of walker couriers, and number of vehicle couriers.

The method 200 can include accessing data indicative of a third order request associated with a third merchant. For instance, the computing system can access data indicative of a third order request associated with a third merchant. The third merchant is located within the merchant area and is associated with a third pick-up location. For instance, as depicted in FIG. 8, the merchant area 800 can be associated with multiple merchants with multiple pick-up locations such as pick-up locations 810A-810D. The merchant area 800 can include a plurality of active walker couriers 805A-805D. Some walker couriers, such as 805A, can be associated with a current order request (e.g., the first order request associated with pick-up location 810A, and the second order request associated with pick-up location 810B).

The method 200 can include additional operations. By way of example, processing logic can determine, based on the first order request, the second order request, and the third order request, that the vehicle courier cannot perform the vehicle portion of the third order request in addition to the vehicle portion of first order request and the vehicle portion of the second order request. By way of example, the method can include determining that the first drop-off location and second drop-off location are located within an acceptable batching threshold, but that the third drop-off location associated with the third order request is outside an acceptable batching threshold. For instance, the batch threshold can be a predetermined (e.g., set) distance between drop-off locations) or can be a value that is determined in real-time based on item characteristics, overall availability of couriers, preparation time of the respective orders, estimated time of arrival at a transition point, or any other relevant factors.

In some instances, processing logic can transmit instructions to a second vehicle courier to perform the vehicle portion of the third order request.

In some implementations, processing logic can determine, based on the location of the first vehicle courier, the location of the second vehicle courier, the first order request, the second order request, and the third order request, that the first walker courier can perform a walking portion of the third order request. By way of example, even though the vehicle portion of the third order request cannot be batched with the first vehicle courier, the walking portion of the third order request can be batched with the respective walking portions of the first order request and the second order request. By way of example, returning to FIG. 8, the third order request can be associated with pick-up location 810C and have an estimated preparation time that will allow for the first walker courier 805A to pick-up the first item, second item, and third item and arrive at the transition point 815 at an acceptable time.

Processing logic can generate updated instructions for the first walker courier to travel to a third pick-up location associated with the third order request.

Processing logic can transmit the updated instructions to the first walker courier to travel to the third pick-up location.

Processing logic can determine that the first walker courier cannot perform a walking portion of the third order request. For instance, turning back to FIG. 8, processing logic can determine that transition point 815 is appropriate for the hand-off for the first order request and the second order request from the first walker courier to the first vehicle courier. Processing logic can determine that transition point 820 is appropriate for the third order request and the second vehicle courier. As such, processing logic can determine an available courier such as courier 805B-805D to perform the walking portion of the third order request.

The examples described herein are for exemplary purposes only and are not meant to limit the disclosure. For instance, an example was described that discussed batching orders based on determined transition points, however a number factors can affect batching as described herein. For instance, overall courier availability, estimated preparation time of items associated with couriers, current locations of devices associated with couriers, a predicted number of future requests, or other relevant factors can be considered when determining when to batch portions of orders opposed to assigning the order to a new courier. Batching can be performed for both the walking portion of the order request as well as the vehicle portion of the order request.

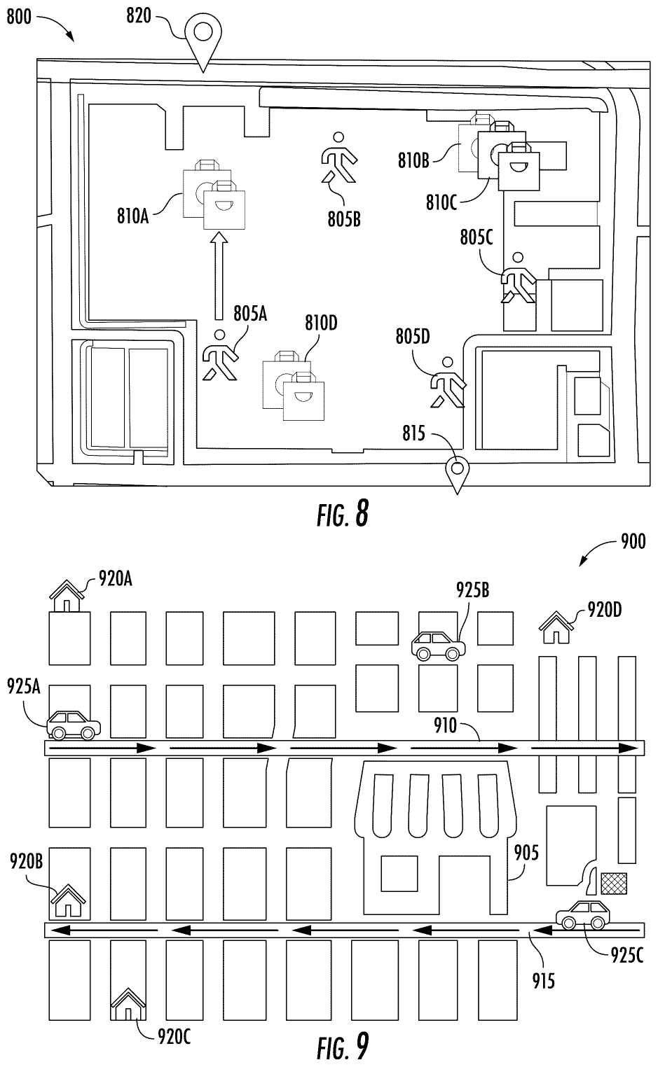

In some instances, batching can be performed based on availability and current location of vehicle couriers as well as drop-off locations. As depicted in FIG. 9, a geographic area 900 can include a merchant area 905. The geographic area can be associated with a number of active vehicle couriers 925A-925C and active order requests associated with drop-off locations 920A-920D. Additionally, geographic area 900 can include, for example geographic features such as one-way street 910 and one-way street 915.

Each of the features depicted in geographic area 900 can affect matching of couriers to order requests as well as batching of vehicle portions of order requests. For instance, continuing with the example described with regard to method 200, drop-off location 920B can be associated with the first order request, drop-off location 920C can be associated with the second order request, and drop-off location 920D can be associated with the third order request. As such, batching the first order request and second order request can be performed due to the proximity between drop-off location 920B and drop-off location 920C being within a block of one another. However, batching the third order request would not be performed because drop-off location 920D is located geographically distant from first drop-off location 920B and second drop-off location 920C.

Additionally, the method can consider the current location and heading of various candidate vehicle couriers to perform matching of the vehicle couriers to the vehicle portion of the respective requests. For instance, vehicle courier 925C can be matched to the first order request and the second order request due to being located such that the merchant area 905 is on the way to the respective drop-off locations (first drop-off location 920B and second drop-off location 920C).

The method can include matching vehicle courier 925A to the vehicle portion of the third order request. While vehicle courier 925A appears to be further from merchant area 905, vehicle courier 925A is located on a one-way street 910 with a heading toward the merchant area 905. As such, vehicle courier 925A can be selected to perform the vehicle portion of the third order request as compared to vehicle courier 925B due to the time necessary for vehicle courier 925B to adjust the heading (e.g., circling a block, taking multiple turns) to arrive at a transition point associated with the merchant area 905.

FIG. 3 depicts a flowchart diagram of an example method for a coordinating service within a merchant area using real-time multi-order batching according to example embodiments of the present disclosure. One or more portion(s) of method 300 can be implemented by processing logic on one or more computing devices such as, for example, the computing devices/computing systems described in FIGS. 1, 14 and 15. Moreover, one or more portion(s) of the method 300 can be implemented as an algorithm on the hardware components of the device(s) described herein (e.g., as in FIGS. 1, 14, and 15). For example, a computing system can include one or more processors and one or more non-transitory, computer-readable media storing instructions that are executable by the one or more processors to cause the computing system to perform operations, the operations including one or more of the operations/portions of method 300. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At operation 305, processing logic can access data indicative of a first order request. The data can be indicative of a first item, a first walker courier, a first pick-up location, and a first drop-off location.

At operation 310, processing logic can access data indicative of a second order request associated with a second merchant. The second merchant can be associated with a second pick-up location.

At operation 315, processing lofic can determine based on the first order request and the second order request, that a vehicle courier can perform a vehicle portion of the first order request and a vehicle portion of the second order request.

At operation 320, processing logic can determine that the first walker courier can pick up a second item associated with the second order request from the second merchant based on: (i) a current location of a computing device associated with the first walker courier, (ii) estimated time of preparation for the second item associated with the second order request, and (iii) an estimated item of arrival for the vehicle courier to a merchant area associated with the first order request and the second order request.

The current location of the computing device associated with the first walker courier can be automatically determined using location-determining hardware of the computing device. Based on automatically updating the current location of the courier computing device, adjustments to matching and batching can be made in real-time.

At operation 325, processing logic can generate updated instructions for the first walker courier to travel to the second pick-up location.

At operation 330, processing lofic can transmit the updated instructions to the first walker courier to perform a walking portion of the second order request. The instructions can include, for instance, a suggested path, information about the second pick-up location including location within the merchant area and specific pick-up instructions tailored to the respective merchant.

At operation 335, processing logic can compute a transition point for the walker courier to meet the vehicle courier with a first item and the second item based on a progress of the vehicle courier to the merchant area.

As described herein, method can include determining an updated transition point based on changes to current locations of the respective courier devices, expected times of arrival, and a comparison to suggested or expected routes between waypoints of the order request. The waypoints can include the initial location of a respective courier, pick-up locations, transition points, or drop-off locations.

At operation 340, processing lofic can transmit data indicative of the transition point to the computing device of the walker courier and a computing device of the vehicle courier. In some implementations, the data indicative of the transition point can include pick-up instructions. Example user interfaces including pick-up instructions are depicted in FIG. 10 to FIG. 13.

FIG. 12 depicts example user interfaces including handoff instructions for the walker courier and vehicle couriers. For instance, FIG. 12 depicts an example walker courier user interface 1205, a first vehicle courier user interface 1210, and a second vehicle courier user interface 1215. The walker courier user interface 1205 can include a summary of the number of handoff/pick-up orders 1220, and details on the two orders that are being handed off. For instance, the order details 1225 for the first order can include information about the vehicle courier including estimated time of arrival, name, care identification number (e.g., license tag), and vehicle type. Additional information can include the name associated with the order request, the merchant associated with the order request, an order identifier, and a number of items in the order. The walker courier user interface 1205 can include a confirm handoff button 1230 which can be selected by a walker courier to indicate that the handoff between the walker courier and vehicle courier has occurred. The walker courier user interface 1205 can include the order details 1225 for the second order.

The first vehicle courier user interface 1210 and the second vehicle courier user interface 1215 can include similar details to those described for the walker courier user interface 1205. For instance, the first vehicle courier user interface 1210 and the second vehicle courier user interface 1215 can include a summary of the number of handoff/pick-up orders 1220, a summary of the order details 1225, and a confirmation button 1230 to be selected to confirm that the pick-up of the order has occurred. In some implementations, responsive to receiving user selection of the confirm pick-up button from the first vehicle courier user interface 1210 or the second vehicle courier user interface 1215, the processing logic can automatically update the walker courier user interface 1205 to indicate that the handoff has occurred (e.g., without the walker courier selecting the confirmation button 1230.

Responsive to the confirmation of the handoff or pick-up, the respective user interfaces can update to the completion user interfaces depicted in FIG. 13. For instance, FIG. 13 includes a walker courier user interface 1305, a first vehicle courier user interface 1310, and a second vehicle courier user interface 1315. The competition user interfaces can include a depiction 1320 of the one or more orders where hand off or pick up has occurred, a help and support element, and a complete handoff button 1325. The complete handoff button 1325 can be selected to indicate that a handoff or pick-up has been completed by the respective couriers.

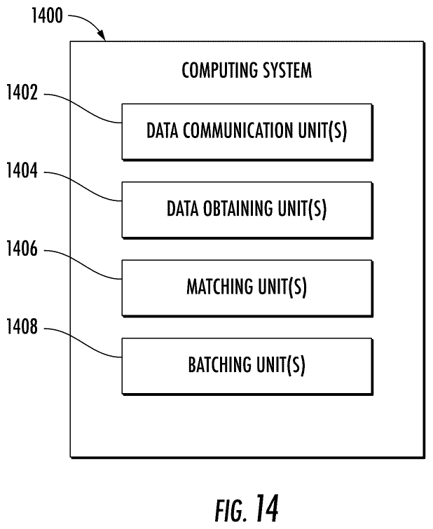

Various means can be configured to perform the methods and processes described herein. For example, FIG. 14 depicts an example computing system 1400 that includes various means according to example embodiments of the present disclosure. The computing system 1400 can be and/or otherwise include, for example, an operations computing system, etc. The computing system 1400 can include data communication unit(s) 1402, data obtaining unit(s) 1404, matching unit(s) 1406, batching unit(s) 1408, and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data communication unit(s) 1402) can be configured to communicate data indicative of a request for a courier to perform a delivery service associated with a delivery order request (e.g., a first and/or second order request).

In addition, the means (e.g., data obtaining unit(s) 1404) can be configured to obtain data associated with a delivery order request. For example, delivery order request can be indicative of a pick-up location, merchant, item, and/or drop-off location associated with a delivery order request. In addition, in some implementations, the means (e.g., the data obtaining unit(s) 1404) can obtain data associated with one or more couriers, one or more merchants, and/or map data indicative of one or more geographic areas.

In addition, the means (e.g., matching unit(s) 1406) can be configured to determine one or more walker couriers and vehicle couriers from a plurality of candidate couriers to perform a walking portion and a vehicle portion of the respective orders. For example, the plurality of candidate couriers can be available to fulfill one or more portions of order requests. By way of example, the plurality of candidate couriers can include walking couriers and vehicle couriers.

In addition, the means (e.g., batching unit(s) 1408) can be configured to determine when to batch walking portions of multiple different order requests or vehicle portions of multiple different order requests with couriers such that the couriers are performing more than one order at the same time. For instance, a portion of an order (e.g., just the walking portion or just the vehicle portion) can be batched compared to existing method which require the entire order to be batched.

These described functions of the means are provided as examples and are not meant to be limiting. The means can be configured for performing any of the operations and functions described herein.

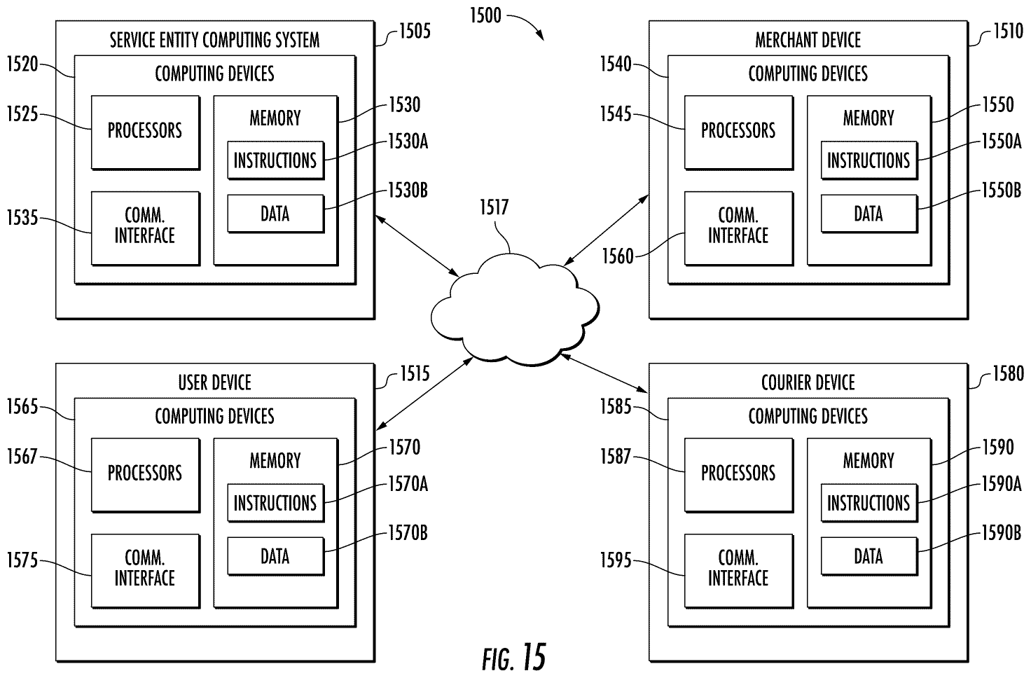

FIG. 15 depicts a block diagram of an example computing system 1500 for implementing computing systems and methods according to example embodiments of the present disclosure. The example computing system 1500 illustrated in FIG. 15 is provided as an example only. The components, computing systems, connections, and/or other aspects illustrated in FIG. 15 are optional and are provided as examples of what is possible, but not required, to implement the present disclosure. The example computing system 1500 can include a service entity computing system 1505 (e.g., that is associated with a delivery service entity). The example computing system 1500 can include one or more merchant devices 1510 (e.g., that is associated with a merchant). The example computing system 1500 can include one or more user devices 1515 (e.g., user device of the user, user device of the operator, user device of the vehicle). The example computing system 1500 can include one or more courier devices (e.g., a device associated with a courier such as a phone, tablet, or other computing device). One or more of the service entities computing system 1505, the merchant device 1510, the user device 1515, or the courier device can be communicatively coupled to one another over one or more communication network(s) 1517. The networks 1517 can correspond to any of the networks described herein.

The computing device(s) 1520 of the service entity computing system 1505 can include processor(s) 1525 and a memory 1530. The one or more processors 1525 can be any suitable processing device (e.g., a processor core, a microprocessor, an ASIC, a FPGA, a controller, a microcontroller) and can be one processor or a plurality of processors that are operatively connected. The memory 1530 can include one or more non-transitory computer-readable storage media, such as RAM, ROM, EEPROM, EPROM, one or more memory devices, flash memory devices, data registrar, etc., and combinations thereof.

The memory 1530 can store information that can be accessed by the one or more processors 1525. For example, the memory 1530 (e.g., one or more non-transitory computer-readable storage mediums, memory devices) can include computer-readable instructions 1530A that can be executed by the one or more processors 1525. The instructions 1530A can be software written in any suitable programming language or can be implemented in hardware. Additionally, or alternatively, the instructions 1530A can be executed in logically and/or virtually separate threads on processor(s) 1525.

For example, the memory 1530 can store instructions 1530A that when executed by the one or more processors 1525 cause the one or more processors 1525 (the service entity computing system 1505) to perform operations such as any of the operations and functions of the computing system(s) (e.g., operations computing system) described herein (or for which the computing system(s) are configured), one or more of the operations and functions for communicating between the computing systems, one or more portions/operations of method 200 or 300, and/or one or more of the other operations and functions of the computing systems described herein.

The memory 1530 can store data 1530B that can be obtained (e.g., acquired, received, retrieved, accessed, created, stored). The data 1530B can include, for example, any of the data/information described herein. In some implementations, the computing device(s) 1520 can obtain data from one or more memories that are remote from the service entity computing system 1505.

The computing device(s) 1520 can also include a communication interface 1535 used to communicate with one or more other computing system(s) remote from the service entity computing system 1505, such as merchant device 1510, user device 1515, and/or courier device 1580. The communication interface 1535 can include any circuits, components, software, etc. for communicating via one or more networks (e.g., network(s) 1517). The communication interface 1535 can include, for example, one or more of a communications controller, receiver, transceiver, transmitter, port, conductors, software and/or hardware for communicating data.

The merchant device 1510 can include one or more computing device(s) 1540 that are remote from the service entity computing system 1505, the user device 1515, and the courier device 1580. The computing device(s) 1540 can include one or more processors 1545 and a memory 1550. The one or more processors 1545 can be any suitable processing device (e.g., a processor core, a microprocessor, an ASIC, a FPGA, a controller, a microcontroller) and can be one processor or a plurality of processors that are operatively connected. The memory 1550 can include one or more tangible, non-transitory computer-readable storage media, such as RAM, ROM, EEPROM, EPROM, one or more memory devices, flash memory devices, data registrar, etc., and combinations thereof.

The memory 1550 can store information that can be accessed by the one or more processors 1545. For example, the memory 1550 (e.g., one or more tangible, non-transitory computer-readable storage media, one or more memory devices) can include computer-readable instructions 1550A that can be executed by the one or more processors 1545. The instructions 1550A can be software written in any suitable programming language or can be implemented in hardware. Additionally, or alternatively, the instructions 1550A can be executed in logically and/or virtually separate threads on processor(s) 1545.

For example, the memory 1550 can store instructions 1550A that when executed by the one or more processors 1545 cause the one or more processors 1545 to perform operations such as any of the operations and functions of the computing system(s) (e.g., merchant server) described herein (or for which the computing system(s) are configured), one or more of the operations and functions for communicating between computing systems, one or more portions/operations of method 200 or 300, and/or one or more of the other operations and functions of the computing systems described herein. The memory 1550 can store data 1550B that can be obtained. The data 1550B can include, for example, any of the data/information described herein.

The computing device(s) 1540 can also include a communication interface 1560 used to communicate with one or more computing system(s) that are remote from the merchant device 1510. The communication interface 1560 can include any circuits, components, software, etc. for communicating via one or more networks (e.g., network(s) 1517). The communication interface 1560 can include, for example, one or more of a communications controller, receiver, transceiver, transmitter, port, conductors, software and/or hardware for communicating data.

The user device 1515 can include one or more computing device(s) 1565 that are remote from the service entity computing system 1505, the merchant device 1510, and the courier device 1580. The computing device(s) 1565 can include one or more processors 1567 and a memory 1570. The one or more processors 1567 can be any suitable processing device (e.g., a processor core, a microprocessor, an ASIC, a FPGA, a controller, a microcontroller) and can be one processor or a plurality of processors that are operatively connected. The memory 1570 can include one or more tangible, non-transitory computer-readable storage media, such as RAM, ROM, EEPROM, EPROM, one or more memory devices, flash memory devices, data registrar, etc., and combinations thereof.

The memory 1570 can store information that can be accessed by the one or more processors 1567. For example, the memory 1570 (e.g., one or more tangible, non-transitory computer-readable storage media, one or more memory devices) can include computer-readable instructions 1570A that can be executed by the one or more processors 1567. The instructions 1570A can be software written in any suitable programming language or can be implemented in hardware. Additionally, or alternatively, the instructions 1570A can be executed in logically and/or virtually separate threads on processor(s) 1567.

For example, the memory 1570 can store instructions 1570A that when executed by the one or more processors 1567 cause the one or more processors 1567 to perform operations such as any of the operations and functions of the computing system(s) (e.g., user devices) described herein (or for which the user device(s) are configured), one or more of the operations and functions for communicating between computing systems, one or more portions/operations of method 200 or 300, and/or one or more of the other operations and functions of the computing systems described herein. The memory 1570 can store data 1570B that can be obtained. The data 1570B can include, for example, any of the data/information described herein.

The computing device(s) 1565 can also include a communication interface 1575 used to communicate computing device/computing system that is remote from the user device 1515, such as merchant device 1510, service entity computing system 1505, or courier device 1580. The communication interface 1575 can include any circuits, components, software, etc. for communicating via one or more networks (e.g., network(s) 1517). The communication interface 1575 can include, for example, one or more of a communications controller, receiver, transceiver, transmitter, port, conductors, software and/or hardware for communicating data.

The computing device(s) 1585 of the courier device 1580 can include processor(s) 1587 and a memory 1590. The one or more processors 1587 can be any suitable processing device (e.g., a processor core, a microprocessor, an ASIC, a FPGA, a controller, a microcontroller) and can be one processor or a plurality of processors that are operatively connected. The memory 1590 can include one or more non-transitory computer-readable storage media, such as RAM, ROM, EEPROM, EPROM, one or more memory devices, flash memory devices, data registrar, etc., and combinations thereof.

The memory 1590 can store information that can be accessed by the one or more processors 1587. For example, the memory 1590 (e.g., one or more non-transitory computer-readable storage mediums, memory devices) can include computer-readable instructions 1590A that can be executed by the one or more processors 1587. The instructions 1590A can be software written in any suitable programming language or can be implemented in hardware. Additionally, or alternatively, the instructions 1590A can be executed in logically and/or virtually separate threads on processor(s) 1587.

For example, the memory 1590 can store instructions 1590A that when executed by the one or more processors 1587 cause the one or more processors 1587 (the courier device 1580) to perform operations such as any of the operations and functions of the display device(s) described herein (or for which such devices are configured), one or more of the operations and functions for communicating between the computing systems/devices, one or more portions/operations of method 200 or 300, and/or one or more of the other operations and functions of the computing systems described herein.

The memory 1590 can store data 1590B that can be obtained (e.g., acquired, received, retrieved, accessed, created, stored). The data 1590B can include, for example, any of the data/information described herein. In some implementations, the computing device(s) 1585 can obtain data from one or more memories that are remote from the courier device 1580.

The computing device(s) 1585 can also include a communication interface 1595 used to communicate with one or more other computing system(s) remote from the courier device 1580, such as merchant device 1510, user device 1515, and/or service entity computing system 1505. The communication interface 1595 can include any circuits, components, software, etc. for communicating via one or more networks (e.g., network(s) 1517). The communication interface 1595 can include, for example, one or more of a communications controller, receiver, transceiver, transmitter, port, conductors, software and/or hardware for communicating data.

The network(s) 1517 can be any type of network or combination of networks that allows for communication between devices. In some implementations, the network(s) 1517 can include one or more of a local area network, wide area network, the Internet, secure network, cellular network, mesh network, peer-to-peer communication link and/or some combination thereof and can include any number of wired or wireless links. Communication over the network(s) 1517 can be accomplished, for example, via a communication interface using any type of protocol, protection scheme, encoding, format, packaging, etc.

Computing tasks discussed herein as being performed at certain computing device(s)/computing systems can instead be performed at another computing device/computing system, or vice versa. Such configurations can be implemented without deviating from the scope of the present disclosure. The use of computer-based computing systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral, for example illustrated purposes and is not meant to be limiting.

What is claimed is:

1. A computer implemented method, including:
accessing data indicative of a first order request associated with a first merchant, wherein the first merchant is located within a merchant area comprising a plurality of merchants, the first order request comprising a first pick-up location and a first drop-off location;
determining a first walker courier to perform a walking portion of the first order request, wherein the walking portion comprises the first walker courier walking to the first pick-up location to retrieve a first item associated with the first order request;
transmitting instructions to a computing device of the first walker courier, the instructions requesting the first walker courier to perform the walking portion of the first order request;
determining a vehicle courier to perform a vehicle portion of the first order request, the vehicle portion comprising the vehicle courier delivering the first item to the first drop-off location;
accessing data indicative of a second order request associated with a second merchant, wherein the second merchant is located within the merchant area and is associated with a second pick-up location;
determining, based on the first order request and the second order request, that the vehicle courier can perform the vehicle portion of the first order request and a vehicle portion of the second order request;
determining that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area;
generating updated instructions for the first walker courier to travel to the second pick-up location;
transmitting the updated instructions to the first walker courier to perform the walking portion of the second order request;
based on a progress of the vehicle courier to the merchant area, computing a transition point for the walker courier to meet the vehicle courier with the first item and the second item; and
transmitting data indicative of the transition point to the computing device of the walker courier and a computing device of the vehicle courier.

2. The computer implemented method of claim 1, wherein there is an initial transition point associated with the first order request, and wherein determining the transition point comprises updating the initial transition point.

3. The computer implemented method of claim 1, wherein determining that the vehicle courier can perform the vehicle portion of the first order request and the vehicle portion of the second order request is based on a spatial proximity of the first drop-off location and a second drop-off location associated with the second order request.

4. The computer implemented method of claim 1, comprising:
accessing data indicative of a third order request associated with a third merchant, wherein the third merchant is located within the merchant area and is associated with a third pick-up location;
determining, based on the first order request, the second order request, and the third order request, that the vehicle courier cannot perform the vehicle portion of the third order request in addition to the vehicle portion of first order request and the vehicle portion of the second order request;
transmitting instructions to a second vehicle courier to perform the vehicle portion of the third order request;
determining, based on the location of the vehicle courier, the location of the second vehicle courier, the first order request, the second order request, and the third order request, that the first walker courier can perform a walking portion of the third order request;
generating updated instructions for the first walker courier to travel to a third pick-up location associated with the third order request; and
transmitting the updated instructions to the first walker courier to travel to the third pick-up location.

5. The computer implemented method of claim 1, comprising:
matching the walker courier to perform the walking portion of the first order request by:
determining a plurality of candidate walker couriers based on data indicative of the plurality of candidate walker couriers being located at the merchant area;
providing the plurality of candidate walker couriers and order request data, as input into a machine-learned model; and
obtaining, as output from the machine-learned model, a plurality of matches between order requests and walker couriers.

6. The computer implemented method of claim 5, comprising:
determining, using a machine-learned model, that the first order request is eligible for a walker courier based on (i) pick-up logistics associated with the merchant area, (ii) one or more pick-up waypoint times, (iii) order preparation time, (iv) courier availability, or (v) time of day.

7. The computer implemented method of claim 6, wherein the pick-up logistics associated with the merchant area comprise: (i) parking availability, (ii) historical time spent at merchant area, or (iii) street geography.

8. The computer implemented method of claim 5, comprising:
obtaining data associated with courier times for a plurality of order requests associated within the merchant area, wherein a first portion of the plurality of order requests are associated with walker courier order requests and a second portion of the plurality of order requests are end-to-end courier requests; and
updating the machine-learned model to better predict when courier time is reduced based on the obtained data.

9. The computer implemented method of claim 8, wherein the data associated with the first portion of the plurality of order requests associated with walker courier order requests comprises a trips per hour count.

10. A computing system, comprising:
one or more processors; and
one or more non-transitory computer readable media storing instructions that are executable by the one or more processors to perform operations, the operations comprising:
accessing data indicative of a first order request, the data being indicative of a first item, a first walker courier, a first pick-up location, and a first drop-off location;
accessing data indicative of a second order request associated with a second merchant, wherein the second merchant is associated with a second pick-up location;
determining based on the first order request and the second order request, that a vehicle courier can perform a vehicle portion of the first order request and a vehicle portion of the second order request;
determining that the first walker courier can pick up a second item associated with the second order request from the second merchant based on: (i) a current location of a computing device associated with the first walker courier, (ii) estimated time of preparation for the second item associated with the second order request, and (iii) an estimated item of arrival for the vehicle courier to a merchant area associated with the first order request and the second order request;
generating updated instructions for the first walker courier to travel to the second pick-up location;
transmitting the updated instructions to the first walker courier to perform a walking portion of the second order request;
based on a progress of the vehicle courier to the merchant area, computing a transition point for the walker courier to meet the vehicle courier with a first item and the second item; and
transmitting data indicative of the transition point to the computing device of the walker courier and a computing device of the vehicle courier.

11. The computing system of claim 10, wherein there is an initial transition point associated with the first order request, and wherein determining the transition point comprises updating the initial transition point.

12. The computing system of claim 10, wherein determining that the vehicle courier can perform the vehicle portion of the first order request and the vehicle portion of the second order request is based on a spatial proximity of the first drop-off location and a second drop-off location associated with the second order request.

13. The computing system of claim 10, comprising:
matching the walker courier to perform the walking portion of the first order request by:
determining a plurality of candidate walker couriers based on data indicative of the plurality of candidate walker couriers being located at the merchant area;
providing the plurality of candidate walker couriers and order request data, as input into a machine-learned model; and
obtaining, as output from the machine-learned model, a plurality of matches between order requests and walker couriers.

14. The computing system of claim 13, comprising:
determining, using a machine-learned model, that the first order request is eligible for a walker courier based on (i) pick-up logistics associated with the merchant area, (ii) one or more pick-up waypoint times, (iii) order preparation time, (iv) courier availability, or (v) time of day.

15. The computing system of claim 14, wherein the pick-up logistics associated with the merchant area comprise: (i) parking availability, (ii) historical time spent at merchant area, or (iii) street geography.

16. The computing system of claim 13, comprising:
obtaining data associated with courier times for a plurality of order requests associated with the merchant area, wherein a portion of the plurality of order requests are associated with walker courier order requests and a second portion of the plurality of order requests are end-to-end courier requests; and
updating the machine-learned model to better predict when courier time is reduced based on the obtained data.

17. The computing system of claim 16, wherein the data associated with the first portion of the plurality of order requests associated with walker courier order requests comprises a trips per hour count.

18. One or more non-transitory computer-readable media storing computer-readable instructions that are executable by one or more processors to perform operations, the operations comprising:
accessing data indicative of a first order request associated with a first merchant, wherein the first merchant is located within a merchant area comprising a plurality of merchants, the first order request comprising a first pick-up location and a first drop-off location;
determining a first walker courier to perform a walking portion of the first order request, wherein the walking portion comprises the first walker courier walking to the first pick-up location to retrieve a first item associated with the first order request;
transmitting instructions to a computing device of the first walker courier, the instructions requesting the first walker courier to perform the walking portion of the first order request;
determining a vehicle courier to perform a vehicle portion of the first order request, the vehicle portion comprising the vehicle courier delivering the first item to the first drop-off location;
accessing data indicative of a second order request associated with a second merchant, wherein the second merchant is located within the merchant area and is associated with a second pick-up location;
determining, based on the first order request and the second order request, that the vehicle courier can perform the vehicle portion of the first order request and a vehicle portion of the second order request;
determining that the first walker courier can pick up a second item associated with the second order request from the second merchant based on: (i) a current location of the computing device associated with the first walker courier, (ii) an estimated time of preparation for the second item associated with the second order request, and (iii) an estimated time of arrival for the vehicle courier to the merchant area;
generating updated instructions for the first walker courier to travel to the second pick-up location;
transmitting the updated instructions to the first walker courier to perform the walking portion of the second order request;
based on a progress of the vehicle courier to the merchant area, computing a transition point for the walker courier to meet the vehicle courier with the first item and the second item; and
transmitting data indicative of the transition point to the computing device of the walker courier and a computing device of the vehicle courier.

19. The non-transitory computer-readable medium of claim 18, wherein there is an initial transition point associated with the first order request, ad wherein determining the transition point comprises updating the initial transition point.

20. The non-transitory computer-readable medium of claim 18, wherein determining that the vehicle courier can perform the vehicle portion of the first order request and the vehicle portion of the second order request is based on a spatial proximity of the first drop-off location and a second drop-off location associated with the second order request.
